(19) United States
(12) Patent Application Publication
(10) Pub. No.: US 2005/0190139 A1
(43) Pub. Date: Sep. 1, 2005

(54) Load capacity driving circuit and liquid crystal driving circuit

(75) Inventor: Tatsumi Fujiyoshi, Miyagi-ken (JP)

Correspondence Address: BEYER WEAVER & THOMAS LLP, P.O. BOX 70250, OAKLAND, CA, 94612-0250, US

(73) Assignee: ALPS ELECTRIC CO., LTD.

(21) Appl. No.: 11/061,409

(22) Filed: Feb. 17, 2005

(30) Foreign Application Priority Data
Feb. 27, 2004 (JP) 2004-054913

(51) Int. Cl. G09G 3/36

(52) U.S. Cl. 345/100

(57) ABSTRACT

The present invention provides a load capacity driving circuit capable of implementing low power consumption. Switches become closed in an initialization period, and a constant current source allows a bias current to flow through a drain of a MOS transistor, which causes a voltage determined by the current to be generated between a source and a gate thereof. A differential voltage between the potential of the gate of the MOS transistor and an input voltage is stored in a capacitor, and a load capacitor is connected to Vss to be discharged. In a subsequent output period, the switches become open, and switches become closed. Then, the capacitor is connected to the load capacitor, and the MOS transistor is turned on due to a decrease in the potential of the gate, so that the load capacitor is charged until the potential of the gate is restored.

### BACKGROUND OF THE INVENTION

1. Field of the Invention

The present invention relates to an analog buffer circuit and a liquid crystal driving circuit having low power consumption, and particularly, to a load capacity driving circuit suitably used for an output end of a source driver of a liquid crystal driving circuit and to a liquid crystal driving circuit using the same.

2. Description of the Related Art

In the related art, as shown in FIG. 6, a circuit using an operational amplifier disclosed in Japanese Unexamined Patent Application Publication No. 2000-338461 is used, for example, as a general load capacity driving circuit for driving a capacitive load, such as a liquid crystal panel. This circuit is composed of pMOS transistors P1 to P3, nMOS transistors N1 and N2, constant current sources I1 and I2, and a capacitor Cc. The pMOS transistors P1 and P2, the nMOS transistors N1 and N2, and the constant current source I1 constitute an input end of the operational amplifier, and the PMOS transistor P3, the capacitor Cc, and the constant current source 12 constitute an output end of the operational amplifier.

Sources S of the pMOS transistors P1 and P2 are connected to Vdd. A drain D of the pMOS transistor P1 is connected to gates G of the pMOS transistors P1 and P2. The drain D of the PMOS transistor P1 is connected to a drain D of the nMOS transistor N1 while a drain D of the pMOS transistor P2 is connected to a drain D of the nMOS transistor N2. Sources S of the nMOS transistors N1 and N2 are connected to Vss via the constant current source 11. The gate G of the nMOS transistor N2 becomes a positive input terminal Tvi of the operational amplifier, and an input voltage Vin is input to the gate via an input resistor Rin.

In addition, a source S of the PMOS transistor P3 is connected to Vdd. The gate G of the PMOS transistor P3, the drain D of the pMOS transistor P2, and the drain D of the nMOS transistor N2, are connected to one end of the capacitor Cc are connected to one node each other. The drain D of the pMOS transistor P3, the other end of the capacitor Cc, and the gate G of the nMOS transistor N1 as a negative input terminal Tvj of the operational amplifier are connected to another node each other. The node becomes an output terminal Tvo of the operation amplifier to which a load capacitor Cload is connected as a capacitive load. The drain D of the pMOS transistor P3 is connected to Vss via the constant current source 12.

In this case, since the output terminal Tvo of the operational amplifier is connected to the negative input terminal Tvj without going through a resistive element, it constitutes the configuration of a voltage follower. That is, an input voltage input to the positive input terminal Tvi of the operational amplifier is output to the output terminal Tvo.

However, the pMOS transistor P3 shown in FIG. 6 used for the output end requires bias currents I1 and I2 for maintaining its operation. In particular, the bias current I2 must have a high value for driving the load. For example, assuming that liquid crystal is employed as the load, the load Cload is 30 pF. In this state, when Vout=5 V is output at the time t=5 sec, the bias current 12 of more than Cload×Vout/t=30 A is required.

However, even when Vout is less than 5V in the related art, the bias current 12 still flows after the output is terminated, so that a power of I2×240×3×5=108 mW is consumed only at the output end of the PMOS transistor P3 when a quarter VGA (QVGA) panel (240 (×3(RGB))×320) is required to be driven.

When the power required for charging or discharging the load is estimated, it typically becomes 5.2 mW (=½×fCV²⁼¹/2×(60 Hz×320)×(30 pF×240×3)×(5V)²). In actual, the bias current is cut off when a writing operation is terminated to correspond to low power consumption. However, it is not sufficient, and most of the bias current is consumed to be a loss within the circuit. That is, when the load capacity driving circuit 15 is used for driving liquid crystal of a portable terminal requiring low power consumption, the power consumption becomes a severe problem.

In addition, the load capacity driving circuit 15 constituted by the above-described MOS transistors has many elements, and the sizes of the transistors, which are internal elements, are large, so that the chip size of the load capacity driving circuit 15 becomes larger.

To solve these problems in the conventional method, it is an object of the present invention to provide a load capacity driving circuit capable of realizing a small-sized chip to obtain the cost-down by reducing the number of elements and of reduce the sizes of the internal transistors.

Further, it is another object of the present invention to provide a liquid crystal driving circuit capable of implementing low power consumption by using the above-described load capacity driving circuit.

In order to achieve the above objects, the present invention provides the following means.

### SUMMARY OF THE INVENTION

According to a first aspect, the present invention provides a load capacity driving circuit for charging a load capacitor connected to an output end, based on a signal input to an input end, in a predefined data period, comprising: an amplifying element whose first electrode is connected to a first power supply; a capacitor whose one end is connected to a control electrode of the amplifying element; a constant current source circuit interposed between a second electrode of the amplifying element and a second power supply; and a control circuit for allowing, in a first half of the data period, the capacitor to be charged with a signal of the input end and for allowing the load capacitor to be connected to the second power supply to be discharged; and for allowing, in a second half of the data period, the other end of the capacitor to be connected to the output end and for allowing the load capacitor to be charged with a current flowing through the second electrode of the amplifying element.

According to this configuration, the load capacity driving circuit allows a voltage of the input end to be stored in the capacitor connected to the control electrode of the amplifying element in the first half of the data period, and allows the load capacitor to be charged in response to the voltage stored in the capacitor in the second half of the data period, so that, the current drivability of the load capacity driving circuit may be low, which allows the transistor of the load capacitor driving circuit to be small-sized.

According to a second aspect, the present invention provides a load capacity driving circuit for charging a load capacitor connected to an output end, based on a signal input to an input end, in a predefined data period, comprising: a metal oxide semiconductor (MOS) transistor whose source is connected to a first power supply; a capacitor whose one end is connected to a gate of the MOS transistor; a constant current source circuit interposed between a drain of the MOS transistor and a second power supply; a first switching means for allowing the other end of the capacitor to be connected to the input end and for allowing the output end to be connected to the second electrode in a first half of the data period; and a second switching means for allowing the other end of the capacitor to be connected to the output end and for allowing the output end to be connected to the drain of the MOS transistor in a second half of the data period.

According to this configuration, the load capacity driving circuit allows a voltage of the input end to be stored in the capacitor connected to the gate of the MOS transistor in the first half of the data period and allows the load capacitor to be charged in response to the voltage stored in the capacitor in the second half of the data period, so that the current drivability of the load capacity driving circuit may be low, which allows the transistor of the load capacitor driving circuit to be small-sized.

In the load capacity driving circuit according to the first aspect or the second aspect, the constant current source circuit sets, to the capacitor, a differential voltage between a voltage of the input terminal, and a voltage of a gate of the amplifying element or a MOS transistor or a voltage of the control electrode of the amplifying element when a bias current determined by the constant current source circuit flows through the amplifying element or the MOS transistor.

According to this configuration, the load capacity driving circuit allows the input voltage to be stored in the capacitor, using as a reference the gate potential of the MOS transistor or the control electrode of the amplifying element which is determined by the bias current in the first half of the data period, and allows the load capacitor to be charged in response to the voltage stored in the capacitor in the second half of the data period. Therefore, it is possible to charge the load capacitor in response to the voltage.

According to a third aspect, the present invention provides a load capacity driving circuit for charging a load capacitor connected to an output end, based on a signal input an input end, in a predefined data period, comprising: a first amplifying element whose first electrode is connected to a first power supply; a first capacitor whose one end is connected to a control electrode of the first amplifying element; a first constant current source circuit whose one end is connected to a second power supply; a second amplifying element whose first electrode is connected to the second power supply; a second capacitor whose one end is connected to a control electrode of the second amplifying element; a second constant current source circuit whose one end is connected to the first power supply; and a control circuit for allowing, in a first half of the data period, the other end of the first constant current source circuit to be connected to the second electrode of the first amplifying element, for allowing the other end of the second constant current source circuit to be connected to the second electrode of the second amplifying element, and for allowing the first and second capacitors to be charged with the signal input to the input end; and for allowing, in a second half of the data period, the other end of each of the first and second capacitors to be connected to the output end and for allowing the load capacitor to be charged with a current flowing through the second electrode of the first amplifying element or to be discharged by a current flowing through the second electrode of the second amplifying element.

According to this configuration, the load capacity driving circuit allows the voltage of the input end to be stored in the capacitor connected to the control electrode of the complementary amplifying element in the first half of the data period, and allows the load capacitor to be charged and discharged in response to the voltage stored in the capacitor in the second half of the data period, so that the load capacitor does not need to be charged after being forcibly discharged, which may reduce unnecessarily consumed power.

According to a fourth aspect, the present invention provides a load capacity driving circuit for charging a load capacitor connected to an output end, based on a signal input to an input end, in a predefined data period, comprising: a first metal oxide semiconductor (MOS) transistor whose source is connected to a first power supply; a first capacitor whose one end is connected to a gate of the first MOS transistor; a first constant current source circuit whose one end is connected to a second power supply; a second MOS transistor whose source is connected to the second power supply; a second capacitor whose one end is connected to a gate of the second MOS transistor; a second constant current source circuit whose one end is connected to the first power supply; a third switching means for allowing, in a first half of the data period, the other end of each of the first and second capacitors to be connected to the input end, for allowing the drain of the first MOS transistor to be connected to the first constant current source circuit, and for allowing the drain of the second MOS transistor to be connected to the second constant current source circuit; and a fourth switching means for allowing, in a second half of the data period, the other end of each of the first and second capacitors to be connected to the output end and for allowing the output end to be connected to the drains of the first and second MOS transistors.

According to this configuration, the load capacity driving circuit allows the voltage of the input end to be stored in the capacitor connected to the gate of the MOS complementary transistor in the first half of the data period and allows the load capacitor to be charged and discharged in response to the voltage stored in the capacitor in the second half of the data period, so that the load capacitor does not need to be charged after being forcibly discharged, which may reduce unnecessarily consumed power.

In the load capacity driving circuit according to the third aspect or the fourth aspect, the first constant current source circuit sets, to the first capacitor, a differential voltage between a voltage of the input terminal, and a voltage of the gate of the first MOS transistor or a voltage of the control electrode of the first amplifying element when a bias current determined by the first constant current source circuit flows through the first amplifying element or the first MOS transistor, and the second constant current source circuit sets, to the second capacitor, a differential voltage between a voltage of the input terminal, and a voltage of the gate of the second MOS transistor or a voltage of the control electrode of the second amplifying element when a bias current determined by the second constant current source circuit flows through the second amplifying element or the second MOS transistor.

According to this configuration, the load capacity driving circuit allows the input voltage to be stored in the first and second capacitors, using as a reference the gate potential of the first and second MOS transistors or the control electrodes of the first and second amplifying elements which are determined by the bias current in the first half of the data period, and allows the load capacitor to be charged in response to the voltages stored in the first and second capacitors in the second half of the data period, so that it is possible to charge the load capacitor in response to the voltages.

According to a fifth aspect, the present invention provides A liquid crystal driving circuit for driving a liquid crystal display panel composed of liquid crystal display pixels arranged in a matrix, comprising: a storage circuit where display data is stored; a digital/analog (D/A) converter for converting data stored in the storage circuit into analog signals; a load capacity driving circuit according to claim 1 for driving the liquid crystal display pixels by means of an output signal from the D/A converter; and a scanning line driving circuit for driving scanning lines of the liquid crystal display panel in a predetermined data period.

According to this configuration, the liquid crystal driving circuit employs the load capacity driving circuit according to any one of the first to fourth aspects, which has low power consumption. Therefore, the current drivability may be suppressed to obtain the configuration optimal for a cellular apparatus.

In addition, according to the load capacity driving circuit of the present invention, power consumption may be lowered, so that the sizes of driving elements, such as transistors, may be decreased when the load capacity driving circuit is integrated to be an IC, which allows the circuit scale to be small-sized and the IC of the load capacity driving circuit to be small-sized. Thus, it is possible to reduce the size of a liquid crystal driving device and to reduce manufacturing costs.

In addition, according to the liquid crystal driving device of the present invention, power consumption may be decreased, so that it is not necessary to seriously take into account the lifetime of a battery of a portable apparatus equipped with the liquid crystal driving device. Accordingly, it is possible to reduce the size and weight of a battery, and thus it is possible to reduce the size and weight of a liquid crystal driving device.

### BRIEF DESCRIPTION OF THE DRAWINGS

FIG. 1 is a circuit diagram illustrating the configuration of a load capacity driving circuit 16a and the opened and closed states of a switch group during an initialization period and an output period in accordance with a first embodiment of the present invention;

FIG. 2 is a view illustrating a voltage variation at each node of the load capacity driving circuit 16a in the first embodiment;

FIG. 3 is a circuit diagram illustrating the configuration of a load capacity driving circuit 16b and the opened and closed states of a switch group during an initialization period and an output period in accordance with a second embodiment of the present invention;

FIG. 4 is a view illustrating a voltage variation at each node of the load capacity driving circuit 16b in the second embodiment;

FIG. 5 is a block diagram illustrating the configuration of a liquid crystal driving circuit in accordance with a third embodiment of the present invention; and

FIG. 6 is a circuit diagram illustrating the circuit configuration of a load capacity driving circuit 15 used for a conventional liquid crystal driving circuit.

### DESCRIPTION OF THE PREFERRED EMBODIMENT

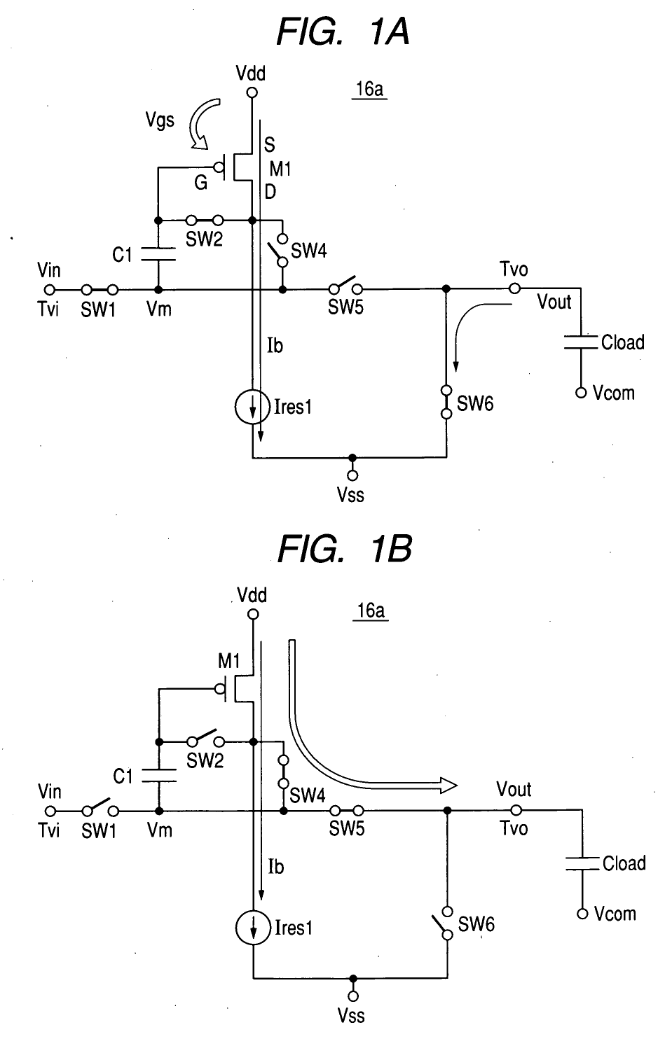

Hereinafter, preferred embodiments of the present invention will be described with reference to the accompanying drawings. FIG. 1A is a circuit diagram illustrating the configuration of a load capacity driving circuit 16a in accordance with a first embodiment of the present invention. Referring to this Figure, the load capacity driving circuit 16a is composed of a pMOS transistor M1 (an amplifying element), a constant current source Ires1 (a constant current circuit) of supplying a constant current having a value Ib, an input capacitor C1 (capacitor), switches SW1, SW2, and SW6 (hereinafter, referred to as first switching means) opened and closed at the same time, and switches SW4 and SW5 (hereinafter, referred to as second switching means). Each of the above-described switches is composed of an analog switch and is opened or closed by a switch control circuit (a control circuit), which is not shown in the figure. The input capacitor C1 preferably has a capacitance of about 0.5 pF to 1 pF. The reason is that, when the capacitance thereof is large, a large area is needed to provide it on a chip, and that, when the capacitance thereof is small, a leakage problem arises.

A source S of the pMOS transistor M1 is connected to Vdd (first power supply), and a gate G of the transistor M1 is connected to one end of the input capacitor C1. A drain D thereof is connected to a negative output end of the constant current source Ires1, and a positive output end of the constant current source Ires1 is connected to Vss (second power supply). The other end of the input capacitor C1 is connected to an input terminal Ti via the switch SW1, and an output terminal Tvo is connected to Vss via the switch SW6. The switch SW2 is interposed between the drain D and the gate G of the pMOS transistor M1. The switch SW4 is interposed between the drain D of the PMOS transistor M1 and a connection point Vm of the input capacitor C1 and the switch SW1, and the switch SW5 is interposed between the output terminal Tvo and the connection point Vm. A load capacitor Cload is, for example, a pixel of a liquid crystal panel of which one electrode is connected to the output terminal Tvo. In addition, Vcom indicates a common electrode.

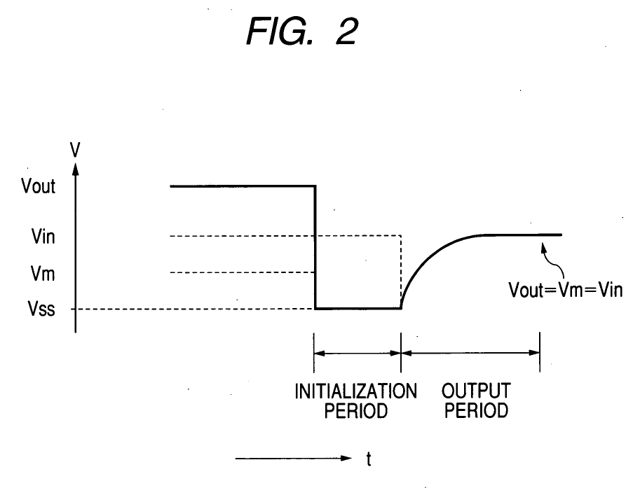

Next, the operation of the load capacity driving circuit 16a according to the first embodiment will be described with reference to FIGS. 1 and 2. FIG. 2 is a view illustrating a voltage variation of each node of the load capacity driving circuit 16a during an initialization period and an output period in the first embodiment.

(a) Initialization Period

First, as shown in FIG. 1A, the switches SW1, SW2, and SW6 are closed to cause the gate G and the drain D of the pMOS transistor M1 to be connected to each other. Then, the pMOS transistor M1 is diode-connected, and thus a bias current Ib flows from the constant current source Ires1 to the drain D. When the bias current Ib flows through the drain D of the pMOS transistor M1, a voltage Vgs between the gate G and the source S is directly and exclusively determined, so that a differential voltage between the potentials of the gate G of the PMOS transistor M1 and the input voltage Vin is stored in the input capacitor C1.

Meanwhile, the load capacitor Cload is connected to Vss by the switch SW6, so that electric charges stored therein are discharged.

(b) Output Period

Next, as shown in FIG. 1B, each switch is switched to cause the load capacity driving circuit 16a to proceed to the output period. More specifically, the switches SW1, SW2, and SW6 are opened so that the disconnection between the input terminal Tvi and the input capacitor C1, the disconnection between the drain D and the gate G of the pMOS transistor M1, and the disconnection between Vss and the output terminal occur, respectively. At the same time, the switches SW4 and SW5 are closed to cause the output terminal Tvo and the drain D of the pMOS transistor M1 to be connected to the connection point Vm between the input capacitor C1 and the switch SW1.

In this case, an input voltage Vin is generally higher than Vss. Therefore, the potential of the connection point Vm between the input capacitor C1 and the switch SW1 instantly becomes Vss as shown in FIG. 2 when the above-described switch connection is carried out. As a result, the potential of the gate G of the pMOS transistor becomes a voltage (Vin−Vss), which causes the pMOS transistor M1 to be turned on. Thus, a current is supplied to the load capacitor Cload, thereby charging the load capacitor Cload.

When an output voltage Vout is increased by charging the load capacitor Cload to be equal to the input voltage Vin, the potential of the gate G of the PMOS transistor M1 becomes equal to the potential (Vdd−Vgs) of the gate G in the initialization period, and the current Ib determined by the voltage Vgs between the source S and the gate G of the pMOS transistor flows through the drain D. The current Ib is not distributed for the load capacitor Cload, but flows through the constant current source Ires1, so that current supply to the load capacitor Cload is stopped.

In this case, the magnitude of the current Ib is not directly associated with the drivability, so that it may be set as a small value. However, when the magnitude of Ib is 0, an offset voltage becomes large which is an error between the output voltage and the input voltage in a state in which current supply to the load capacitor Cload is stopped. Accordingly, the current Ib is set as small as possible in a tolerable range of the offset voltage. For example, the offset voltage is required to be sufficiently smaller than the differential voltage between the driving voltages of gray scale levels adjacent to each other in the defined display gray scale level of liquid crystal, and the current Ib is defined so as to have an offset voltage of ±20 mV or less when Vdd is 5 V and Vss is 0 V. In this case, since the defined current Ib flows as described above, the PMOS transistor M1 is used in a substantially middle region between a transition region and a saturation region.

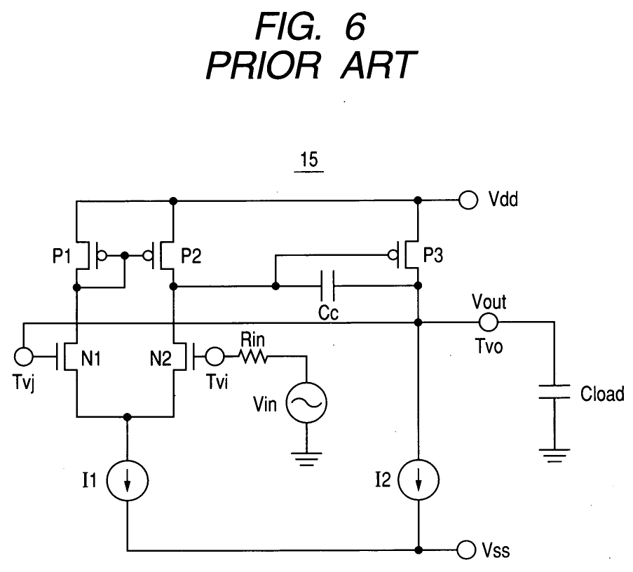

Meanwhile, the magnitude of a bias current 12 in a load capacity driving circuit 15 of a conventional liquid crystal driving circuit as shown in FIG. 6 is directly associated with drivability, and is also associated with a driving frequency and load capacity. Therefore, the magnitude must be set to have a high value to some extent. In particular, it is set about ten times higher than the current Ib in the above-described load capacity driving circuit 16a. As such, the load capacity driving circuit 16a may have the current Ib of the constant current source Ires1 significantly smaller than that of the conventional load capacity driving circuit 15.

In addition, the bias current I2 must be set to be high in the load capacity driving circuit 15 of the conventional liquid crystal driving circuit as described above, so that the size of the transistor for driving the bias current I2 accordingly needs to be larger. However, the MOS transistor M1 constituting the load capacity driving circuit 16a of the present embodiment may have the current Ib of the constant current source Ires1 decreased by 1/10, so that the size of the transistor may be decreased by at least ¼ or less, as compared to a MOS transistor P3 of the load capacity driving current 15 as shown in FIG. 6.

As such, according to the above-described embodiment, the MOS transistor M1 has the configuration that does not require high drivability, so that power consumption may be reduced. In addition, the size of the MOS transistor to be employed may be decreased, so that the number of elements in the load capacity driving circuit 16a may be reduced. Accordingly, the chip of the load capacity driving circuit 16a may be miniaturized, which results in a reduction in costs.

Next, a second embodiment of the present invention will be described.

In the first embodiment, the pMOS transistor M1, serving as a driving transistor, has only a function of supplying a current, so that the load capacitor Cload must be first set to Vss during the initialization period, which causes electric charges to be excessively discharged from the load capacitor Cload, so that power is unnecessarily consumed. This problem is settled by the second embodiment.

A load capacity driving circuit 16b of the second embodiment operates by repeatedly performing two states, such as the initialization period and the output period, similar to the load capacity driving circuit 16a, and outputs the output voltage Vout resulted from the input voltage Vin with those two periods being used as one period.

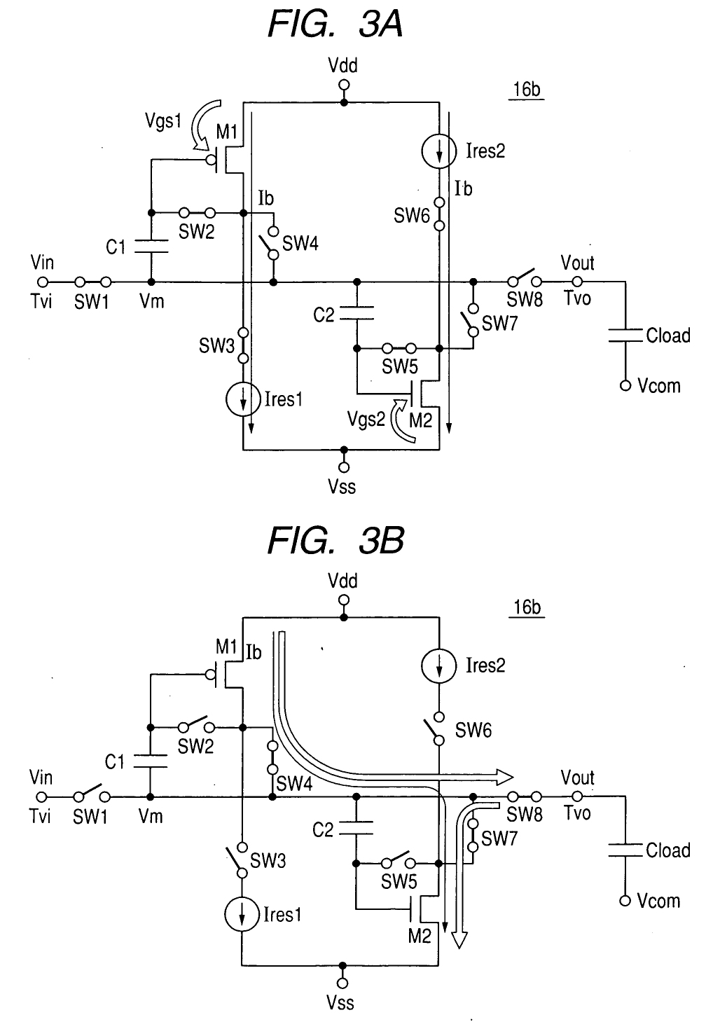

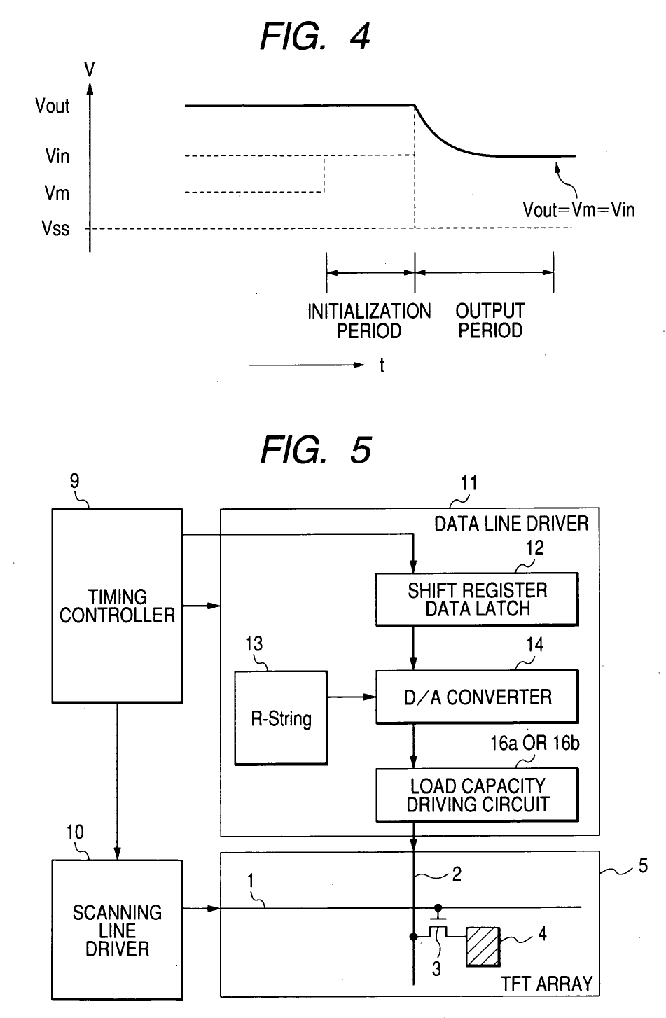

FIG. 3A is a circuit diagram illustrating the configuration of the load capacity driving circuit 16b and the connection states of switch groups during the initialization period in accordance with the second embodiment of the present invention. FIG. 3B is an equivalent circuit diagram illustrating the connection states of the switch groups during the output period of the load capacity driving circuit 16b of the second embodiment. In addition, FIG. 4 is a view illustrating a voltage variation at each node of the load capacity driving circuit 16b during the initialization period and the output period in the second embodiment.

Referring to FIGS. 3A and 3B, the load capacity driving circuit 16b includes a pMOS transistor M1 (first amplifying element), an nMOS transistor M2 (second amplifying element), an input capacitor C1 (first capacitor), an input capacitor C2 (second capacitor), a constant current source Ires1 of supplying a constant current 1b (first constant current circuit), a constant current source Ires2 (second constant current circuit), switches SW1, SW2, SW3, SW5, and SW6 (hereinafter, referred to as first switch means) opened or closed to be associated with each other at the same time, and switches SW4, SW7, and SW8 (hereinafter, referred to as second switch means) opened or closed to be associated with each other at the same time. Each of the above-described switch groups is composed of an analog switch and is opened and closed by a switch control circuit (control circuit), which is not shown.

A source S of the pMOS transistor M1 is connected to Vss, and a gate G thereof is connected to one end of the input capacitor C1. A drain D thereof is connected to a negative output end of the constant current source Ires1 via the switch SW3, and a positive output end of the constant current source Ires1 is connected to Vss. The other end of the input capacitor C1 is connected to an input terminal Tvi via the switch SW1. The switch SW2 is interposed between the drain D and the gate G of the pMOS transistor M1. The switch SW4 is interposed between the drain D of the PMOS transistor M1 and the connection point Vm between the input capacitor C1 and the switch SW1.

In addition, a source S of the nMOS transistor M2 is connected to Vss, and the gate G thereof is connected to one end of the input capacitor C2. The drain D is connected to a positive output end of the constant current source Ires2, and a negative output end of the constant current source Ires1 is connected to Vdd. The other end of the input capacitor C2 is connected to the connection point Vm between the input capacitor C1 and the switch SW1. The switch SW5 is interposed between the drain D and the gate G of the nMOS transistor M2. The switch SW7 is interposed between the drain D of the nMOS transistor M2 and the connection point Vm between the input capacitor C2 and the switch SW1, and the load capacitor Cload connected to the output terminal Tvo is connected to the connection point Vm between the input capacitor C1 and the switch SW1 via the switch SW8.

Next, the operation of the load capacity driving circuit 16b according to the second embodiment will be described with reference to FIGS. 3 and 4.

(a) Initialization Period

First, as shown in FIG. 3A, the switches SW1, SW2, SW3, SW5, and SW6 are closed to cause the gate G of the pMOS transistor M1 to be connected to the drain D of the nMOS transistor M2, so that the PMOS transistor M1 and nMOS transistor M2 are diode-connected. Thus, the constant current source Ires1 or the constant current source Ires2 causes the bias current Ib to flow through the drain D. When the bias current Ib flows through the drain D of the pMOS transistor M1 or the nMOS transistor M2, voltages Vgs1 and Vgs2 between the gate G and the source S of the pMOS transistor and between the gate G and the source S of the nMOS transistor are directly and exclusively determined, so that a differential voltage between the potential of the gate G of the pMOS transistor M1 and the input voltage Vin is stored in the input capacitor C1, and a differential voltage between the potential of the gate G of the nMOS transistor M2 and the input voltage Vin is stored in the input capacitor C2.

Meanwhile, the load capacitor Cload is disconnected from the load capacity driving circuit 16b by the switch SW8, so that electric charges stored therein are not discharged.

(b) Output Period

Next, as shown in FIG. 3B, each switch is switched to cause the load capacity driving circuit 16b to proceed to the output period. More specific, the switches SW1, SW2, SW3, SW5, and SW6 become open such that disconnection occurs between the input terminal Tvi and the input capacitor C1, between the drain D and the gate G of the PMOS transistor M1 and the negative output end of the constant current source Ires1, and between the drain D and the gate G of the pMOS transistor M1 and the positive output end of the constant current source Ires2, respectively. At the same time, the switches SW4, SW7 and SW8 become closed to cause the output terminal Tvo, the drain D of the pMOS transistor M1, and the drain D of the nMOS transistor M2 to be connected to the connection point Vm between the input capacitor C1 and the switch SW1.

It is assumed that the output voltage Vout has a higher potential than the input voltage Vin. In this case, as shown in FIG. 4, the potential of the connection point Vm between the input capacitor C1 and the switch Sw1 instantly becomes Vout. As a result, the potentials of the gates G of the nMOS transistor M2 and the pMOS transistor M1 become higher than the potential of the drain D of the PMOS transistor M1 by the potential (Vout−Vin), which causes the pMOS transistor M1 to be turned off and the nMOS transistor M2 to be turned on, so that electric charges stored in the load capacitor Cload are discharged via the nMOS transistor M2. Accordingly, when the output voltage Vout falls to the input voltage Vin, discharging from the load capacitor Cload is completed. In this case, a method of setting the current Ib is the same as in the first embodiment. In this way, the output voltage Vout becomes equal to the input voltage Vin.

On the contrary, when the output voltage Vout had a potential lower than the input voltage Vin at the beginning, the nMOS transistor M2 is turned off, and the PMOS transistor M1 is turned on, so that a current is supplied to the load capacitor Cload. Accordingly, when the output voltage Vout starts to rise to reach the input voltage Vin, contrary to the above, the charging of the load capacitor Cload is completed in the same procedure.

As described above, according to the above-mentioned embodiment, the pMOS transistor and the nMOS transistor are complementarily constituted, and push-pull operations are carried out for the same, so that the discharging operation of the load capacitor Cload during the initialization period as in the first embodiment is not needed, which leads to lower power consumption. For example, in the first embodiment, even when the load capacitor Cload is charged to have a value close to the input voltage Vin, the load capacity driving circuit makes the load capacitor Cload forcibly connected to Vss, so that the load capacitor Cload is discharged during the initialization period, and makes it charged up to the input voltage Vin during the output period. Therefore, it is possible to settle a problem of unnecessary power consumption.

Next, a third embodiment of the present invention will be described.

In the third embodiment, the load capacity driving circuit 16a or 16b according to the first or second embodiment is subjected to an application to constitute a liquid crystal driving circuit for, driving a liquid crystal panel.

FIG. 5 is a circuit diagram illustrating the configuration of the liquid crystal driving circuit in accordance with the third embodiment of the present invention. Referring to FIG. 5, the liquid crystal driving circuit includes scanning lines 1, data lines 2, thin film transistors (TFTs) 3, pixel electrodes 4 (liquid crystal display pixels), a TFT array 5 constituted of a counter electrode (not shown) with liquid crystal interposed therebetween, a timing controller 9, a scanning line driver 10 (scanning line driving circuit), and a data line driver 11.

The data line driver 11 is composed of a shift register data latch 12 (storage circuit), an R-string (resistance string) 13, a D/A converter 14 (digital-to-analog converter), and the load capacity driving circuit 16a according to the first embodiment or the load capacity driving circuit 16b according to the second embodiment.

In addition, when the above-described QVGA panel is driven, 240 by 3 load capacity driving circuits 16a or 16b are required.

Next, the operation of the liquid crystal driving circuit according to the present embodiment will be described.

The timing controller 9 outputs synchronizing signals to the data line driver 11 and the scanning line driver 10. In the data line driver 11, digital signals serially input to each pixel unit from the shift register data latch 12 is distributed to each data line, based on the synchronizing signals output from the timing controller 9, and the signals are subjected to D/A conversion by the R-string (resistance string) 13 and the D/A converter 14 (digital-to-analog converter). Then, the converted analog voltage is output to the load capacity driving circuit 16a or 16b. The load capacity driving circuit 16a or 16b transmits the same voltage as the input analog voltage to the data lines 2. The scanning line driver 10 sequentially selects the scanning lines 1, based on the synchronizing signals output from the timing controller 9, and makes the TFT 3 sequentially turned on of which gate is connected to the selected scanning line 1. The TFT 3 turned on by the scanning line 1 outputs to the pixel electrode 4 the analog signal which has been output to the data line 2 to allow electric charges to be written, thereby changing an electro-optical property (transmittance) of the liquid crystal of the pixel electrode 4 to perform liquid crystal display.

In this case, the load capacity driving circuit consumes the most power in the liquid crystal driving circuit. Therefore, by applying the above-described load capacity driving circuit 16a or 16b having low power consumption to the liquid crystal driving circuit, it is possible to realize a liquid crystal driving circuit having low power consumption.

In particular, in the operation of driving the liquid crystal, it is preferable that a voltage be intermittently output for the sequential operation of the scanning lines. Therefore, the operation of the load capacity driving circuit 16a or 16b is effective wherein the two states of the initialization period and the output period may be repeated and these periods may be taken as one period to cause the output voltage Vout to be output by the input voltage Vin.

According to the embodiments as described above, the whole power consumption of the liquid crystal driving circuit may be decreased by using the load capacity driving circuit having low power consumption.

As mentioned above, the embodiments of the present invention have been described with reference to the drawings. However, the specific configurations are not limited to these embodiments, but design changes thereof can be made without departing from the scope of the present invention.

1. A load capacity driving circuit for charging a load capacitor connected to an output end, based on a signal input to an input end, in a predefined data period, comprising:
an amplifying element whose first electrode is connected to a first power supply;
a capacitor whose one end is connected to a control electrode of the amplifying element;
a constant current source circuit interposed between a second electrode of the amplifying element and a second power supply; and
a control circuit for allowing, in a first half of the data period, the capacitor to be charged with a signal of the input end and for allowing the load capacitor to be connected to the second power supply to be discharged; and for allowing, in a second half of the data period, the other end of the capacitor to be connected to the output end and for allowing the load capacitor to be charged with a current flowing through the second electrode of the amplifying element.

2. A load capacity driving circuit for charging a load capacitor connected to an output end, based on a signal input to an input end, in a predefined data period, comprising:
a metal oxide semiconductor (MOS) transistor whose source is connected to a first power supply;
a capacitor whose one end is connected to a gate of the MOS transistor;
a constant current source circuit interposed between a drain of the MOS transistor and a second power supply;
a first switching means for allowing the other end of the capacitor to be connected to the input end and for allowing the output end to be connected to the second electrode in a first half of the data period; and
a second switching means for allowing the other end of the capacitor to be connected to the output end and for allowing the output end to be connected to the drain of the MOS transistor in a second half of the data period.

3. The load capacity driving circuit according to claim 1,
wherein the constant current source circuit sets, to the capacitor, a differential voltage between a voltage of the input terminal, and a voltage of a gate of the amplifying element or a MOS transistor or a voltage of the control electrode of the amplifying element when a bias current determined by the constant current source circuit flows through the amplifying element or the MOS transistor.

4. The load capacity driving circuit according to claim 2,
wherein the constant current source circuit sets, to the capacitor, a differential voltage between a voltage of the input terminal, and a voltage of a gate of the MOS transistor or a voltage of the control electrode of the amplifying element when a bias current determined by the constant current source circuit flows through the amplifying element or the MOS transistor.

5. A load capacity driving circuit for charging a load capacitor connected to an output end, based on a signal input an input end, in a predefined data period, comprising:
a first amplifying element whose first electrode is connected to a first power supply;
a first capacitor whose one end is connected to a control electrode of the first amplifying element;
a first constant current source circuit whose one end is connected to a second power supply;
a second amplifying element whose first electrode is connected to the second power supply;
a second capacitor whose one end is connected to a control electrode of the second amplifying element;
a second constant current source circuit whose one end is connected to the first power supply; and
a control circuit for allowing, in a first half of the data period, the other end of the first constant current source circuit to be connected to the second electrode of the first amplifying element, for allowing the other end of the second constant current source circuit to be connected to the second electrode of the second amplifying element, and for allowing the first and second capacitors to be charged with the signal input to the input end; and for allowing, in a second half of the data period, the other end of each of the first and second capacitors to be connected to the output end and for allowing the load capacitor to be charged with a current flowing through the second electrode of the first amplifying element or to be discharged by a current flowing through the second electrode of the second amplifying element.

6. A load capacity driving circuit for charging a load capacitor connected to an output end, based on a signal input to an input end, in a predefined data period, comprising:
a first metal oxide semiconductor (MOS) transistor whose source is connected to a first power supply;
a first capacitor whose one end is connected to a gate of the first MOS transistor;
a first constant current source circuit whose one end is connected to a second power supply;
a second MOS transistor whose source is connected to the second power supply;
a second capacitor whose one end is connected to a gate of the second MOS transistor;
a second constant current source circuit whose one end is connected to the first power supply;
a third switching means for allowing, in a first half of the data period, the other end of each of the first and second capacitors to be connected to the input end, for allowing the drain of the first MOS transistor to be connected to the first constant current source circuit, and for allowing the drain of the second MOS transistor to be connected to the second constant current source circuit; and
a fourth switching means for allowing, in a second half of the data period, the other end of each of the first and second capacitors to be connected to the output end and for allowing the output end to be connected to the drains of the first and second MOS transistors.

7. The load capacity driving circuit according to claim 5,
wherein the first constant current source circuit sets, to the first capacitor, a differential voltage between a voltage of the input terminal, and a voltage of the gate of the first MOS transistor or a voltage of the control electrode of the first amplifying element when a bias current determined by the first constant current source circuit flows through the first amplifying element or the first MOS transistor, and
the second constant current source circuit sets, to the second capacitor, a differential voltage between a voltage of the input terminal, and a voltage of the gate of the second MOS transistor or a voltage of the control electrode of the second amplifying element when a bias current determined by the second constant current source circuit flows through the second amplifying element or the second MOS transistor.

8. The load capacity driving circuit according to claim 6,
wherein the first constant current source circuit sets, to the first capacitor, a differential voltage between a voltage of the input terminal, and a voltage of the gate of the first MOS transistor or a voltage of the control electrode of the first amplifying element when a bias current determined by the first constant current source circuit flows through the first amplifying element or the first MOS transistor, and
the second constant current source circuit sets, to the second capacitor, a differential voltage between a voltage of the input terminal, and a voltage of the gate of the second MOS transistor or a voltage of the control electrode of the second amplifying element when a bias current determined by the second constant current source circuit flows through the second amplifying element or the second MOS transistor.

9. A liquid crystal driving circuit for driving a liquid crystal display panel composed of liquid crystal display pixels arranged in a matrix, comprising:
a storage circuit where display data is stored;
a digital/analog (D/A) converter for converting data stored in the storage circuit into analog signals;
a load capacity driving circuit according to claim 1 for driving the liquid crystal display pixels by means of an output signal from the D/A converter; and
a scanning line driving circuit for driving scanning lines of the liquid crystal display panel in a predetermined data period.

10. A liquid crystal driving circuit for driving a liquid crystal display panel composed of liquid crystal display pixels arranged in a matrix, comprising:
a storage circuit where display data is stored;
a digital/analog (D/A) converter for converting data stored in the storage circuit into analog signals;
a load capacity driving circuit according to claim 2 for driving the liquid crystal display pixels by means of an output signal from the D/A converter; and
a scanning line driving circuit for driving scanning lines of the liquid crystal display panel in a predetermined data period.

11. A liquid crystal driving circuit for driving a liquid crystal display panel composed of liquid crystal display pixels arranged in a matrix, comprising:
a storage circuit where display data is stored;
a digital/analog (D/A) converter for converting data stored in the storage circuit into analog signals;
a load capacity driving circuit according to claim 5 for driving the liquid crystal display pixels by means of an output signal from the DA converter; and
a scanning line driving circuit for driving scanning lines of the liquid crystal display panel in a predetermined data period.

12. A liquid crystal driving circuit for driving a liquid crystal display panel composed of liquid crystal display pixels arranged in a matrix, comprising:
a storage circuit where display data is stored;
a digital/analog (D/A) converter for converting data stored in the storage circuit into analog signals;
a load capacity driving circuit according to claim 6 for driving the liquid crystal display pixels by means of an output signal from the DA converter; and
a scanning line driving circuit for driving scanning lines of the liquid crystal display panel in a predetermined data period.
